(19) United States
(12) Patent Application Publication
(10) Pub. No.: US 2015/0286011 A1
(43) Pub. Date: Oct. 8, 2015

(54) FIBER OPTIC CONNECTORS

(71) Applicant: ADC TELECOMMUNICATIONS, INC., Berwyn, PA (US)

(72) Inventor: Ponharith Nhep, Savage, MN (US)

(21) Appl. No.: 14/438,434

(22) PCT Filed: Oct. 25, 2013
(86) PCT No.: PCT/US2013/066768

§ 371 Date: Apr. 24, 2015

Related U.S. Application Data
(60) Provisional application No. 61/718,218, filed on Oct. 25, 2012.

(51) Int. Cl. G02B 6/38

(52) U.S. Cl. CPC G02B 6/387; G02B 6/3825; G02B 6/3871; G02B 6/3893; G02B 6/3821

(57) ABSTRACT

A single piece hub and ferrule assembly for a fiber optic connector includes: a first portion sized to receive a jacket of a fiber optic cable; a second portion sized to receive a fiber of the fiber optic cable; and a hub portion configured to engage a housing of the fiber optic connector; wherein the first portion, the second portion, and the hub portion are all formed as an integrally-molded piece.

### CROSS REFERENCE TO RELATED APPLICATION

This application is being filed on 25 Oct. 2013, as a PCT International Patent application and claims priority to U.S. Patent Application Ser. No. 61/718,218 filed on 25 Oct. 2012, the disclosure of which is incorporated herein by reference in its entirety.

### BACKGROUND

Fiber optic cables are used in the telecommunication industry to transmit light signals in high-speed data and communication systems. A standard fiber optic cable includes a fiber with an inner light transmitting optical core. Surrounding the fiber is an outer protective casing.

A fiber terminates at a fiber optic connector. Connectors are frequently used to non-permanently connect and disconnect optical elements in a fiber optic transmission system. There are many different fiber optic connector types. Some of the more common connectors are LC, FC, and SC connectors. Other types of connectors include ST and D4-type connectors.

A typical fiber optic connector, such as an SC connector, includes a housing having a front end positioned opposite from a rear end. The front end of the connector housing is commonly configured to be inserted within an adapter. An example adapter is shown in U.S. Pat. No. 5,317,663, assigned to ADC Telecommunications, Inc. The connector typically further includes a ferrule that is positioned within the front and rear ends of the housing, and adjacent the front end. The ferrule is axially moveable relative to the housing, and is spring biased toward the front of the connector. The fiber optic cable has an end that is stripped. The stripped end includes a bare fiber that extends into the connector and through the ferrule.

A connector, such as the connector described above, is mated to another connector within an adapter like the adapter of U.S. Pat. No. 5,317,663. A first connector is received within the front portion of the adapter, and a second fiber is received within the rear portion of the adapter. When two connectors are fully received within an adapter, the ferrules (and hence the fibers internal to the ferrule) contact or are in close proximity to each other to provide for signal transmission between the fibers. Another connector type (LX.5 connector) and mating adapter is shown in U.S. Pat. No. 6,142,676, assigned to ADC Telecommunications, Inc.

### SUMMARY

In one aspect, a single piece hub and ferrule assembly for a fiber optic connector includes: a first portion sized to receive a jacket of a fiber optic cable; a second portion sized to receive a fiber of the fiber optic cable; and a hub portion configured to engage a housing of the fiber optic connector; wherein the first portion, the second portion, and the hub portion are all formed as an integrally-molded piece.

In another aspect, a fiber optic connector includes: a front housing; a rear housing; a single piece hub and ferrule assembly, the single piece hub and ferrule assembly including: a first portion sized to receive a jacket of a fiber optic cable; a second portion sized to receive a fiber of the fiber optic cable; and a hub portion configured to engage the front housing of the fiber optic connector; and a spring positioned in the fiber optic connector to push the single piece hub and ferrule assembly towards the front housing.

### DESCRIPTION OF THE DRAWINGS

FIG. 1 is an exploded view of an example fiber optic connector.

FIG. 2 is a side view of the connector of FIG. 1 in a fully assembled state.

FIG. 3 is a cross-sectional view taken along line A-A of the connector shown in FIG. 2.

FIG. 4 is a cross-sectional view taken along line E-E of the connector shown in FIG. 3.

FIG. 5 is a side view of a one piece hub and ferrule assembly of the connector shown in FIG. 1.

FIG. 6 is an end view of the one piece hub and ferrule assembly shown in FIG. 5.

FIG. 7 is a cross-sectional view taken along line H-H of the one piece hub and ferrule assembly shown in FIG. 5.

FIG. 8 is another cross-sectional view taken along line H-H of the one piece hub and ferrule assembly shown in FIG. 6 including a fiber optic cable.

### DETAILED DESCRIPTION

The present disclosure is directed towards fiber optic connectors. Although not so limited, an appreciation of the various aspects of the present disclosure will be gained through a discussion of the examples provided below.

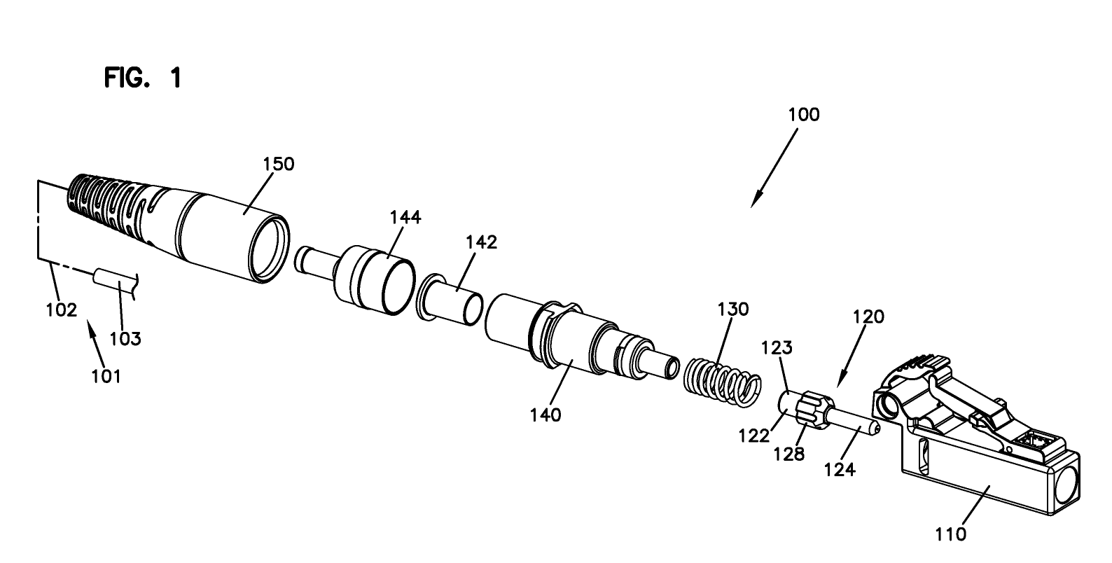

FIG. 1 is an exploded view of an example connector 100. In this example, the connector 100 is an LC connector, although other connector types can be used. The connector 100 includes a front housing 110, a rear housing 140, and a boot 150.

The connector 100 further includes an insertion cap 142 and a crimp sleeve 324. The crimp sleeve 324 is inserted over a rear portion of the rear housing 140 and captures the insertion cap 142 therebetween. The crimp sleeve 324 is used to crimp the cable 101. Addition details regarding an LC connector configured in a similar manner are provided in U.S. patent application Ser. No. 13/420,286 filed on Mar. 14, 2012, the entirety of which is hereby incorporated by reference.

Also included is a hub/ferrule assembly 120 with a hub 122 and a ferrule 124. The hub 122 includes an anti-rotation portion 128 and an elongated cylindrical rear portion 123. The hub 122 is connected to the ferrule 124, such as with adhesive or with an interference fit. A spring 130 is also provided. A fiber optic cable 101 is shown including a fiber 102 and a jacket 103.

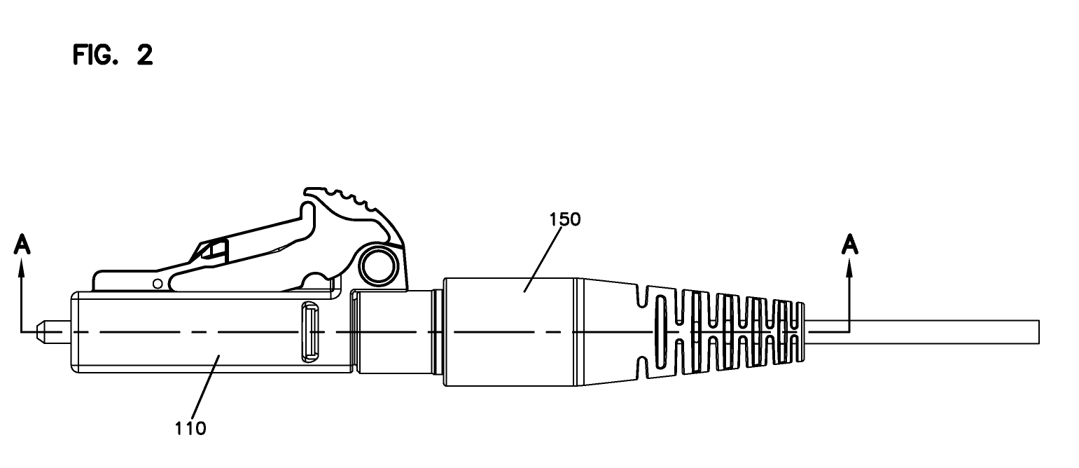

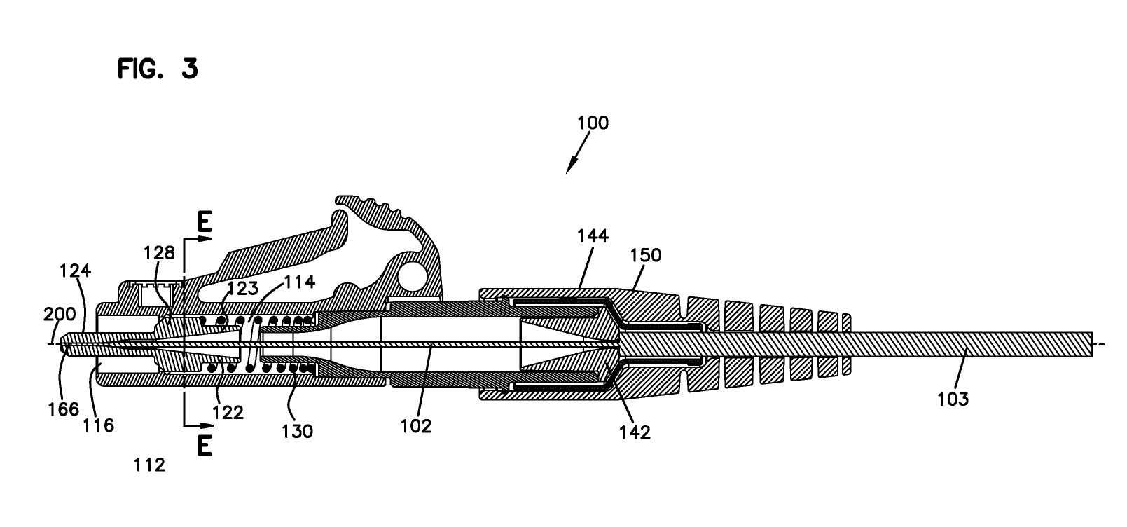

In FIGS. 2 and 3, the connector 100 is shown in a fully assembled state.

The front housing 110 of the connector 100 extends along a longitudinal axis 200 and defines an anti-rotation seat 112 and a cavity 114. The ferrule 124 extends through a front bore 116 of the front housing 110. The anti-rotation portion 128 of the hub 122 is slidingly engaged along the longitudinal axis 200 in the anti-rotation seat 112.

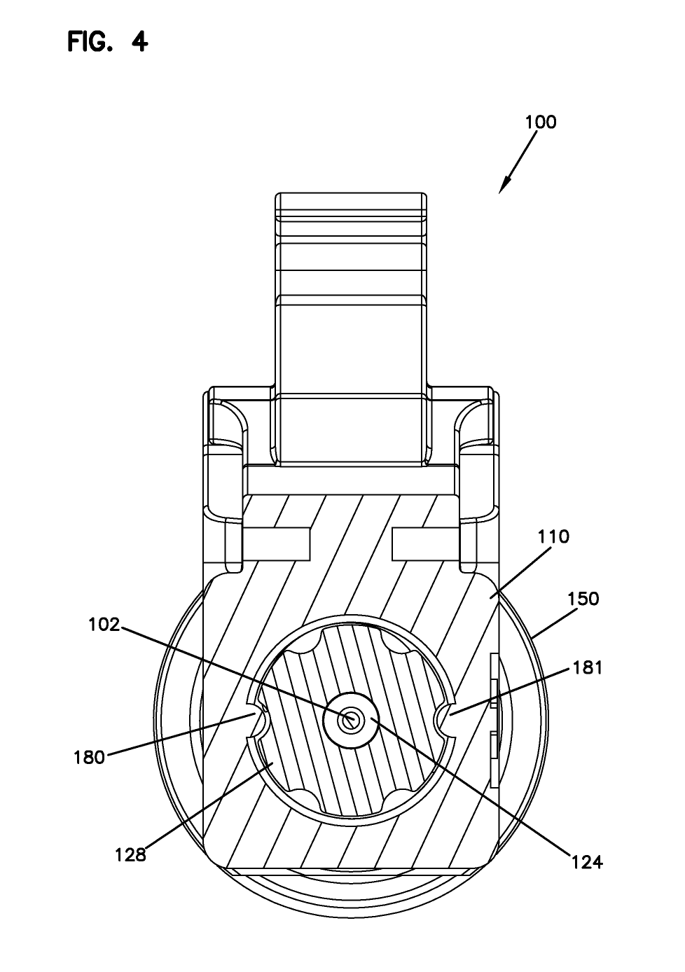

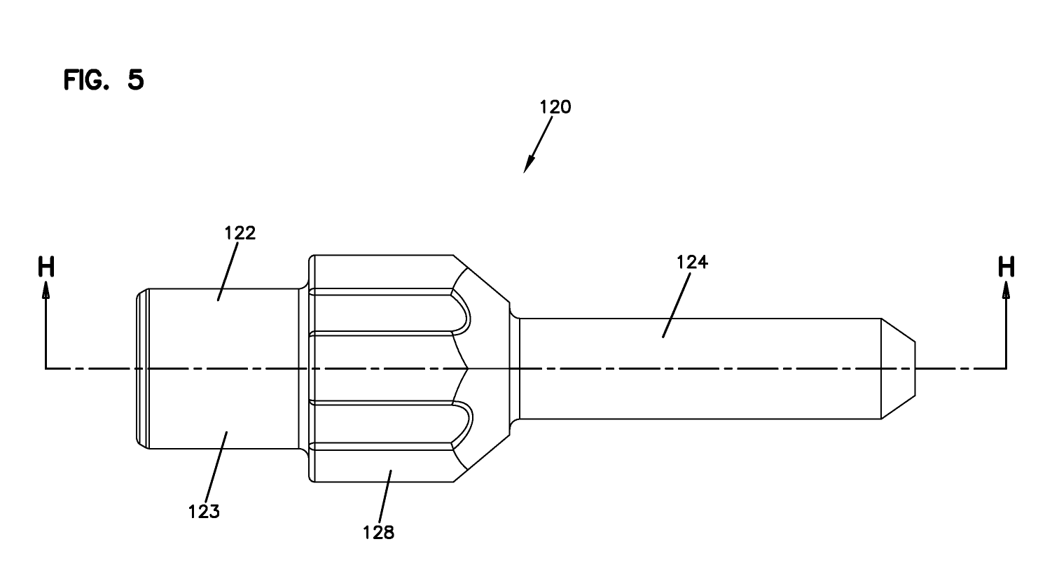

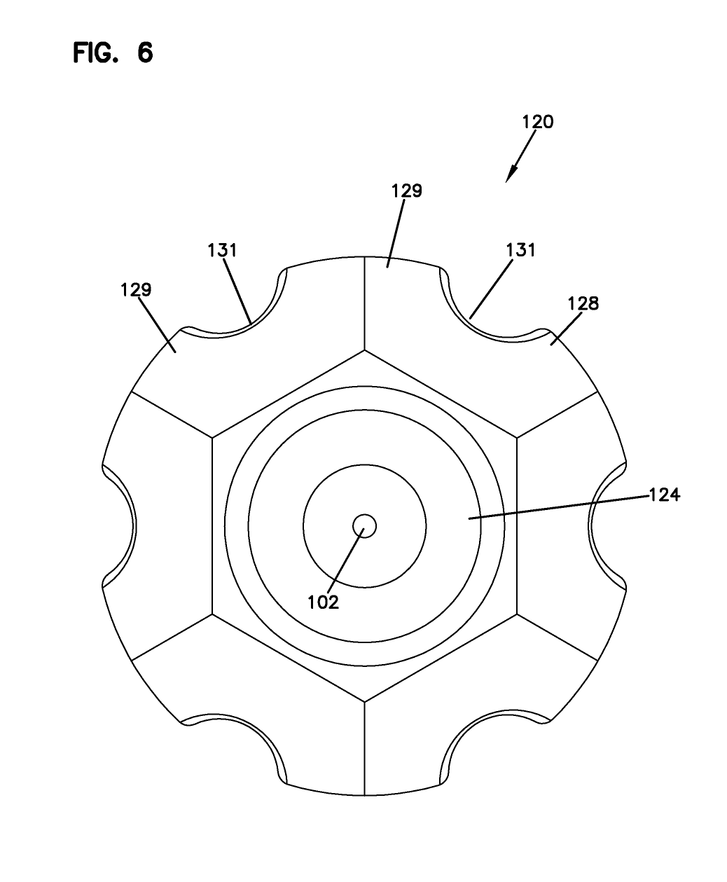

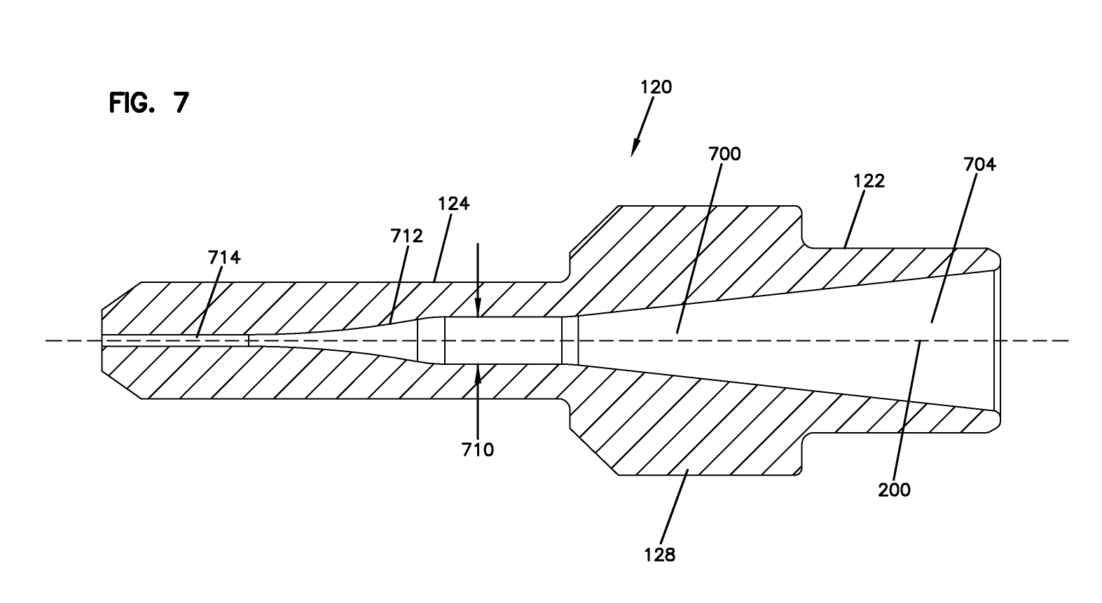

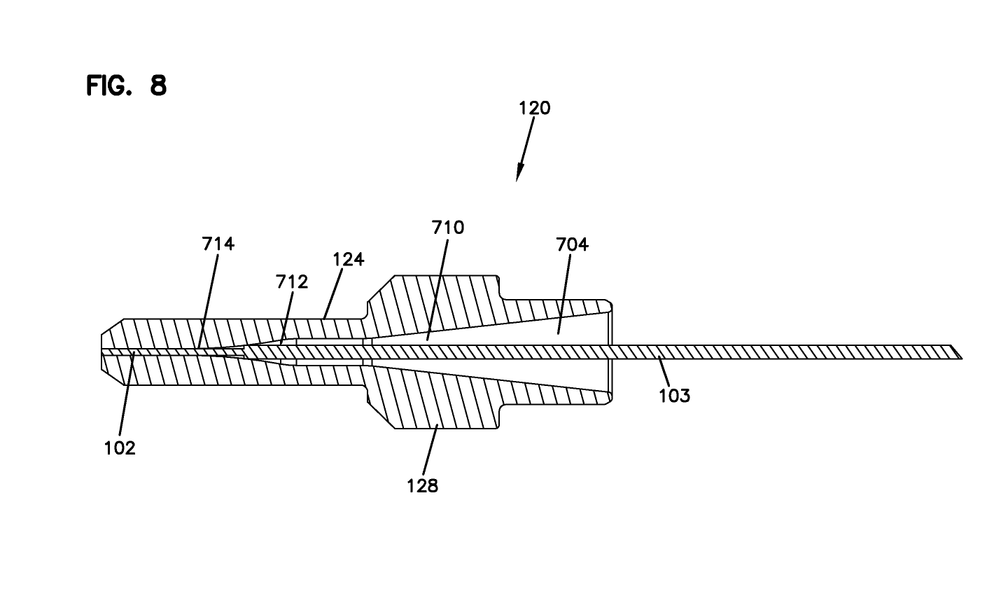

In the example embodiment, the anti-rotation portion 128 is shaped in a hexagonal configuration (see FIGS. 5-8) and the anti-rotation seat 112 defines a seat of a complementary geometry. Knobs 180 and 181 form the anti-rotation seat 112 (see FIG. 4). The anti-rotation portion 128 and the anti-rotation seat 112 allow for sliding along the longitudinal axis 200, but prevent relative rotation. Specifically, the anti-rotation portion 128 forms six lobes 129 with indentations 131 formed between each of the lobes 129. The knobs 180, 181 engage opposite lobes 129 to fix the rotational orientation of the hub 120 relative to the front housing 110.

Other mating shapes and configurations are also possible. The elongated cylindrical rear portion 123 of the hub 122 extends into the cavity 114 of the front housing 110.

The spring 130 surrounds the elongated cylindrical rear portion 123 of the hub 122. The spring 130 is captured between the anti-rotation portion 128 and the rear housing 140. The spring 130 functions to bias the anti-rotation portion 128 of the hub 122 into the anti-rotation seat 112 of the front housing 110. Because the ferrule 124 is connected to the hub 122, the spring 130 also functions to bias the ferrule 124 in a forward direction through the front bore 116.

FIGS. 2 and 3 show the final assembled positions of the front and rear housings 110 and 140. An interference fit also is present when the front and rear housings 110 and 140 are partially inserted, as will be described below. The fiber optic cable 101 is extended through the front and rear housings 110 and 140 and is glued to the ferrule 124.

In example embodiments, the connector 100 is tunable. If tunable, the connector 100 can be tuned using various methods. For example, in one method, the connector 100 can be tuned by pushing the hub/ferrule assembly 120 backwards and rotating the hub/ferrule assembly 120 to a desired orientation when the connector 100 is in a partially assembled state. Details of such a tuning process can be found in U.S. Pat. No. 6,629,782, which is hereby incorporated by reference. In another example, the desired orientation can be determined after the connector 100 is assembled, and an outer key can be added to the connector 100 to indicate that orientation. Details of such a tuning process can be found in U.S. Pat. No. 5,212,752, which is hereby incorporated by reference. Other methods of tuning can also be used.

Referring now to FIGS. 5-8, the hub/ferrule assembly 120 with a hub 122 and a ferrule 124 is shown. In this example, the hub/ferrule assembly 120, including both the hub 122 and the ferrule 124, is formed as a single piece. In other words, the hub/ferrule assembly 120 is a single, integrally molded piece.

The hub/ferrule assembly 120 includes an internal passage 700 extending along the longitudinal axis 200 of the connector 100. The internal passage 700 is sized to receive the terminal end of the fiber optic cable 101, including a portion of the fiber 102 and the jacket 103.

An internal diameter 710 of the internal passage 700 is sized to receive the jacket 103 of the fiber optic cable 101. In this example, the internal passage 700 includes a lead-in portion 704 that tapers to the diameter 710, with the lead-in portion 704 allowing for the introduction of the jacket 103 into the internal passage 700. In one example, the lead-in portion 704 has a maximum diameter of 0.060 inches, and the internal diameter 710 is 0.030 inches. Other dimensions and configurations are possible.

The internal passage 700 narrows at a region 712 as the internal passage 700 extends towards the ferrule 124. A diameter 714 of the internal passage 700 is sized to receive the fiber 102 of the fiber optic cable 101 extending therethrough. In this example, the diameter 714 is 0.0050 inches, although other dimensions can again be used.

In some examples, the fiber 102 and/or the jacket 103 can be fixed within the internal passage 700 using various methods, such as by an adhesive. In other examples, one or both of the fiber 102 and the jacket 103 are retained within the passage 700 by a frictional fit.

In example embodiments, the hub/ferrule assembly 120 is manufactured of a polymeric material using a molding process. In one example, the hub/ferrule assembly 120 is made of Polyphenylene Sulfide (PPS) using an injection molding process. Other materials and molding processes can be used.

Several advantageous can be associated with an integral hub/ferrule assembly. One advantage is that the integral hub/ferrule assembly can be manufactured more efficiently, since steps requiring the hub to be connected to the ferrule are eliminated. Another advantage is that the integral hub/ferrule assembly can be more robust than other designs made out of multiple pieces.

Although the examples shown herein illustrate an LC connector, other connector types can be used. For example, in alternative embodiments, an SC or LX.5 connector can be used, such as that illustrated in U.S. Pat. No. 6,629,782.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A single piece hub and ferrule assembly for a fiber optic connector, the single piece hub and ferrule assembly comprising:
a first portion sized to receive a jacket of a fiber optic cable;
a second portion sized to receive a fiber of the fiber optic cable; and
a hub portion configured to engage a housing of the fiber optic connector;
wherein the first portion, the second portion, and the hub portion are all formed as an integrally-molded piece.

2. The single piece hub and ferrule assembly of claim 1, wherein the hub portion is hexagonal.

3. The single piece hub and ferrule assembly of claim 2, wherein the single piece hub and ferrule assembly is injection molded.

4. The single piece hub and ferrule assembly of claim 3, wherein the single piece hub and ferrule assembly defines an internal passage extending therethrough, the internal passage including a larger diameter area at the first portion sized to receive the jacket, and the internal passage including a smaller diameter area at the second portion sized to receive the fiber.

5. The single piece hub and ferrule assembly of claim 4, wherein the internal passage includes a taper as the internal passage extends from the larger diameter area to the smaller diameter area.

6. The single piece hub and ferrule assembly of claim 1, wherein the single piece hub and ferrule assembly is injection molded.

7. The single piece hub and ferrule assembly of claim 1, wherein the single piece hub and ferrule assembly defines an internal passage extending therethrough, the internal passage including a larger diameter area at the first portion sized to receive the jacket, and the internal passage including a smaller diameter area at the second portion sized to receive the fiber.

8. The single piece hub and ferrule assembly of claim 7, wherein the internal passage includes a taper as the internal passage extends from the larger diameter area to the smaller diameter area.

9. A fiber optic connector, comprising:
a front housing;
a rear housing;
a single piece hub and ferrule assembly, the single piece hub and ferrule assembly including:
a first portion sized to receive a jacket of a fiber optic cable;
a second portion sized to receive a fiber of the fiber optic cable; and
a hub portion configured to engage the front housing of the fiber optic connector; and
a spring positioned in the fiber optic connector to push the single piece hub and ferrule assembly towards the front housing.

10. The fiber optic connector of claim 9, wherein the hub portion is hexagonal.

11. The fiber optic connector of claim 10, wherein the single piece hub and ferrule assembly is injection molded.

12. The fiber optic connector of claim 11, wherein the single piece hub and ferrule assembly defines an internal passage extending therethrough, the internal passage including a larger diameter area at the first portion sized to receive the jacket, and the internal passage including a smaller diameter area at the second portion sized to receive the fiber.

13. The fiber optic connector of claim 12, wherein the internal passage includes a taper as the internal passage extends from the larger diameter area to the smaller diameter area.

14. The fiber optic connector of claim 9, wherein the single piece hub and ferrule assembly is injection molded.

15. The fiber optic connector of claim 9, wherein the single piece hub and ferrule assembly defines an internal passage extending therethrough, the internal passage including a larger diameter area at the first portion sized to receive the jacket, and the internal passage including a smaller diameter area at the second portion sized to receive the fiber.

16. The fiber optic connector of claim 15, wherein the internal passage includes a taper as the internal passage extends from the larger diameter area to the smaller diameter area.

17. A fiber optic connector, comprising:
a front housing defining an anti-rotation set defining a plurality of knobs;
a rear housing;
a single piece hub and ferrule assembly, the single piece hub and ferrule assembly including:
a first portion sized to receive a jacket of a fiber optic cable;
a second portion sized to receive a fiber of the fiber optic cable; and
a hub portion configured to engage the front housing of the fiber optic connector, the hub including an anti-rotation portion including a plurality of lobes; and
a spring positioned in the fiber optic connector to push the single piece hub and ferrule assembly towards the front housing;
wherein the knobs of the front housing engage the lobes of the hub portion to fix a rotational orientation of the single piece hub and ferrule assembly relative to the front housing.

18. The fiber optic connector of claim 17, wherein the anti-rotation portion of the hub portion is hexagonal.

19. The fiber optic connector of claim 17, wherein the single piece hub and ferrule assembly defines an internal passage extending therethrough, the internal passage including a larger diameter area at the first portion sized to receive the jacket, and the internal passage including a smaller diameter area at the second portion sized to receive the fiber.

20. The fiber optic connector of claim 19, wherein the internal passage includes a taper as the internal passage extends from the larger diameter area to the smaller diameter area.
